(19) United States
(12) Patent Application Publication
(10) Pub. No.: US 2001/0032836 A1
(43) Pub. Date: Oct. 25, 2001

(54) Rebar end heating tool

(76) Inventor: N. Tim Larsen, Eugene, OR (US)

Correspondence Address: Kolisch, Hartwell, Dickinson, McCormack & Heuser, 200 Pacific Building, 520 S.W. Yamhill Street, Portland, OR, 97204, US

(21) Appl. No.: 09/797,537

(22) Filed: Feb. 28, 2001

Related U.S. Application Data
(60) Provisional application No. 60/185,248, filed on Feb. 28, 2000.

(51) Int. Cl. H05B 3/00

(52) U.S. Cl. 219/228; 219/535

(57) ABSTRACT

A rebar end heating tool for heating cylindrically shaped pieces of rebar includes handle structure, and a heating unit. The heating unit is coupled with the handle structure and constructed with the capability of heating a piece of rebar having a diameter in the range of ⅜ inches to 1¼ inches to a temperature of about 500° F. in less than about ten seconds.

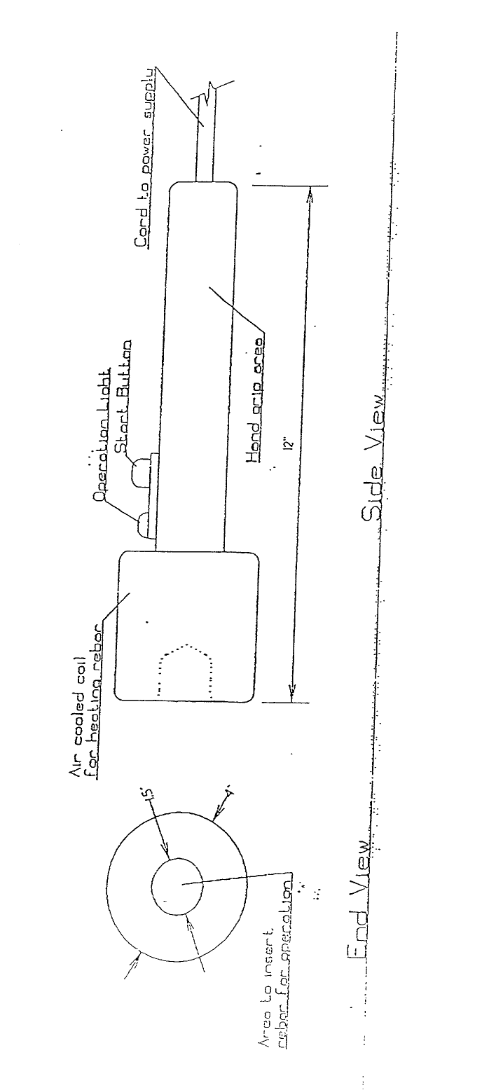

### CROSS-REFERENCE TO RELATED APPLICATIONS

This application claims priority to U.S. Provisional Patent Application Serial No. 60/185,248, filed on Feb. 28, 2001 and entitled REBAR END HEATING TOOL.

### APPEARANCE

The exterior of the tool consists of a handle, a heating unit, and a control panel.

The tool's handle is cylindrical, approximately two inches in diameter, and approximately eight inches in length. A power supply cord comes from one end of the handle; this end shall be considered the back of the handle, as well as the back of the tool. The other end of the handle, shall be considered the front of the handle.

The heating unit is cylindrical, approximately four inches in diameter, and approximately four inches in length. The end which we shall consider the back of the heating unit is attached (end to end) to the front of the handle. The other end of the heating unit, which we shall consider the front of the heating unit—as well as the front of the tool—has a cylindrical opening in the center, approximately one and one-half inches diameter and approximately one and one-half inches deep.

The control panel runs lengthwise, parallel to the handle, and it is approximately two inches long by three-fourths inch wide and is approximately one-eighth inch thick. It is positioned along what shall be considered the top side of the handle, approximately one-fourth inch behind the heating unit. Rising from the front portion of the control panel is an operation indicator light, approximately one-fourth inch high and approximately one-half inch wide. Rising from the back portion of the control panel is a start button, approximately one-half inch high and approximately one-half inch wide.

### Composition and Internal Components

The handle is hollow and is composed of a non-conductive material. It houses wiring for the power supply, the heating unit, and the control panel.

The heating unit is composed of a non-conductive material. It houses a five Kilowatt heating coil which is air cooled and will heat rebar in sizes ranging from three-eighth inch to one and one-fourth inch diameter to a temperature of 500 degrees Fahrenheit in less than ten seconds.

### Purpose

The tool is used for the purpose of heating the ends of rebar in preparation for the application of thermally cured powder. This task is part of an innovative new process for coating the ends of powder coated rebar.

### Development of the Tool

I began building a model with a water cooled coil, however, prior to completing my water cooled model (unit was done but for the power supply) I determined that an air cooled coil would be the best design for the tool. I was aware of air cooled coil technology and knew it would allow the tool to be lighter, therefore much easier to handle.

### DESCRIPTION OF THE PROCESS

The new process for which this tool was designed, came about as a means of replacing the dirty, labor intensive process which is currently standard practice for treating the cut ends of powder coated rebar. Currently the cut ends are hand painted with a two part liquid epoxy. With the new process the two part liquid epoxy is eliminated and the rebar ends are coated with the same thermally cured powder as that which covers the rest of the rebar. As a protectant against corrosion, thermally cured powder dramatically out performs two part liquid epoxy.

The rebar end heating tool is used in the first part of this two part process. The tool is used to heat the end of the rebar to 480 degrees Fahrenheit. The second part of the process, which does not involve the end heating tool, consists of applying powder to the heated rebar end. This is accomplished using an electrostatic spray gun, on a specially designed table which has an area where powder overspray is collected—so that the powder does not pollute the atmosphere, and can be reused.

I claim:

1. A rebar end heating tool for heating cylindrically shaped pieces of rebar, comprising:
handle structure;
a heating unit coupled with the handle structure and constructed with the capability of heating a piece of rebar having a diameter in the range of ⅜ inches to 1¼ inches to a temperature of about 500° F. in less than about ten seconds.
